(19) United States
(12) Patent Application Publication
(10) Pub. No.: US 2003/0023333 A1
(43) Pub. Date: Jan. 30, 2003

(54) Control method and industrial production installation with web control system

(76) Inventor: Fritz Birkle, Nassenbeuren (DE)

Correspondence Address: McGlew & Tuttle, Scarborough Station, Scarborough, NY, 10510-0827, US

(21) Appl. No.: 10/220,744

(22) PCT Filed: Mar. 9, 2001
(86) PCT No.: PCT/EP01/02653

(30) Foreign Application Priority Data
Mar. 10, 2000 (DE) 200-04-370.6

(51) Int. Cl. G06F 19/00

(52) U.S. Cl. 700/96; 700/117; 709/201

(57) ABSTRACT

The invention relates to a control method and to an industrial production installation (1), especially for manufacturing parts of unfinished vehicle bodies. The production installation (1) comprises one or more intelligent application components (3), especially multiple-axle robots (4), welding, gluing or chucking installations or comparable treatment installations, and at least one installation control (10). Said installation control (10) controls the intelligent application components (3) by a web control system (2) by means of a Fast Ethernet data network (16). The intelligent application components (3) are provided with a respective web server (13) with at least one individual homepage (17) according to internet standard, web control can also take place within the application components (3), the control elements (25) and the associated device elements (26) of the intelligent application components being interlinked via a web control system (2) and a Fast Ethernet data network (16). The device elements (26) are provided with an intelligence (12) or with an intelligent interface (24) of their own and each with a web server (13) with at least one individual homepage (17).

The present invention pertains to a control process and an industrial production system, especially for the manufacture of components of vehicle bodies, with the features in the preamble of the principal process claim and of the principal device claim.

Such a control process and an industrial production system have been known from EP-A 0 825 506. The production system has a system control in the form of a so-called Server Digital Data Processor and a plurality of application components. The system control is designed as a programmable logic control (PLC) and is connected to input devices and display devices via a network. The system control and the input and display devices are equipped with Internet WEB browsers, the communication in this network taking place according to Internet standards under the TCP/IP protocol. However, only information and programs are exchanged here. The network is limited to the system control and the input and display devices. The application components are controlled by the system control in the conventional manner with a proprietary bus system. A special control program is to be prepared for each application. Special applications, such as spot welding, bonding, stud welding, etc., are controlled with special application controls. Special software programs are likewise prepared and used for this. Proprietary bus systems are likewise used for the information exchange with the sensors and actuators as well as between the individual controls of the application components. The prior-art production system requires a great effort for designing, construction, building and putting into operation. The intelligent system components, being proprietary and noncompatible systems, are very expensive. Special hardware and software are to be designed, constructed, built and put into operation for each production system and for each application. Moreover, information can be made available from the component level to the system level at a very great effort only. The operator of a production system must, moreover, be familiarized with the corresponding controls and operating and observation devices.

The object of the present invention is to improve such an industrial production system.

The present invention accomplishes this object with the features described in the principal claim.

The use of a WEB control system between the system control and the intelligent application components instead of the current proprietary bus systems has the advantage that the effort on the hardware and software side for designing, constructing, building and putting into operation the production system is substantially reduced. The costs are correspondingly lower. Internet-compatible techniques, which originate from the office world and are available in a wide selection at low cost, are used in the hardware and software for the WEB control system. The techniques meet the widespread Internet standards. They are compatible with one another and are open as a general standard. They are tested and have a high reliability in operation.

The system control can control the intelligent application components in real time via the WEB control system. Control commands, feedback and other similar information necessary for a direct control are exchanged between the application control and the application components. In addition, status messages, information on devices, programs, etc., can be transmitted.

Not only is the design and programming effort substantially reduced due to such a standardization as a result of the elimination of the proprietary systems. The operation and the maintenance by the user of the system is also simplified and facilitated. A uniform user/system interface also has a favorable effect here. The system users and the employees are frequently already familiar with browsers and homepages. This technique, known and standard from the use of the Internet, facilitates the use of the production system. Changeovers to new systems or changes in existing production systems also become easier due to the standardization.

The WEB control system has the special advantage that via homepages, it makes possible the observation and the diagnosis of all connected intelligent system components at each WEB server equipped with a suitable display and also at each possibly existing, separate display and operating device in the system. Moreover, via a connection to a system network of the same type or to other connected data networks of the same type, observation and diagnosis may also take place at any desired and suitable point in these networks. Moreover, operation and control of the individual intelligent system components may also be performed, in principle, by any display and operating device in the WEB control system and in other connected data networks of the same type. However, this may be limited for other reasons, e.g., because of safety engineering requirements. These potential possibilities of intervention include a very great variety of forms of influencing, e.g., manual control, reprogramming, the rerecording or exchange of programs, the modification of parameters, etc.

A WEB control system may exist not only between the system control or system controls and the individual control parts of the intelligent application components. Such a WEB control system may also be present within the intelligent application components, in which case the control parts control the device parts of the application components, which said device parts are likewise equipped with suitable intelligences, in the above-described manner. The WEB control system existing at the system level with its data network and the WEB control system existing within the individual system components with corresponding data network (Fast Ethernet lines) may be linked with one another. The transparency and the control possibilities of the production system are increased even further as a result.

Additional advantageous embodiments of the present invention are described in the subclaims.

The present invention is schematically represented in the drawings as examples. Specifically,

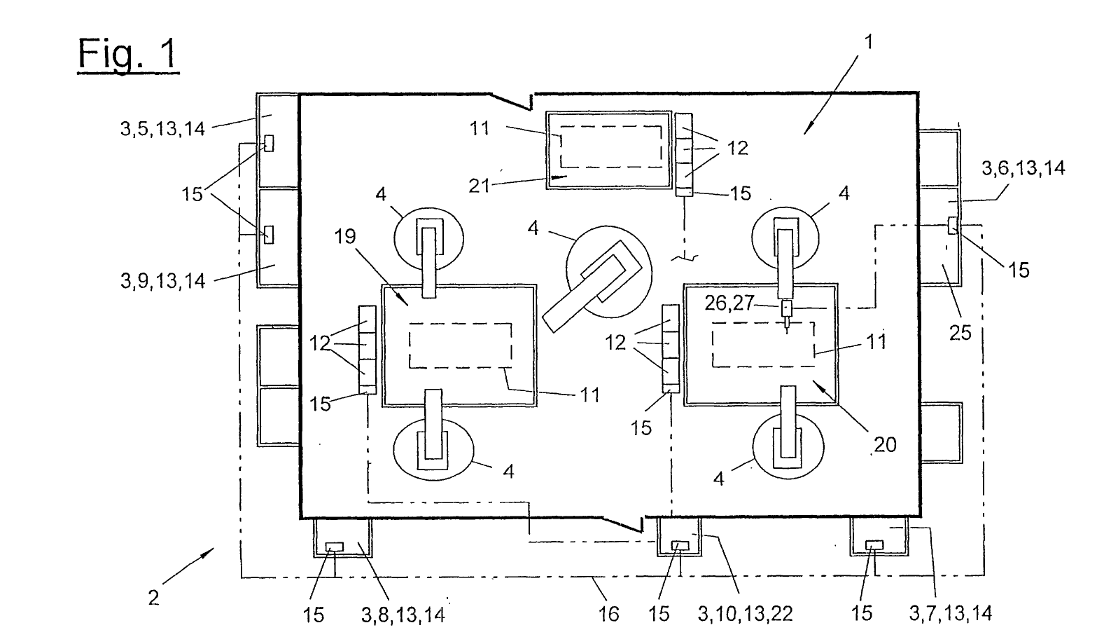

FIG. 1 shows a production system with a plurality of intelligent system components,

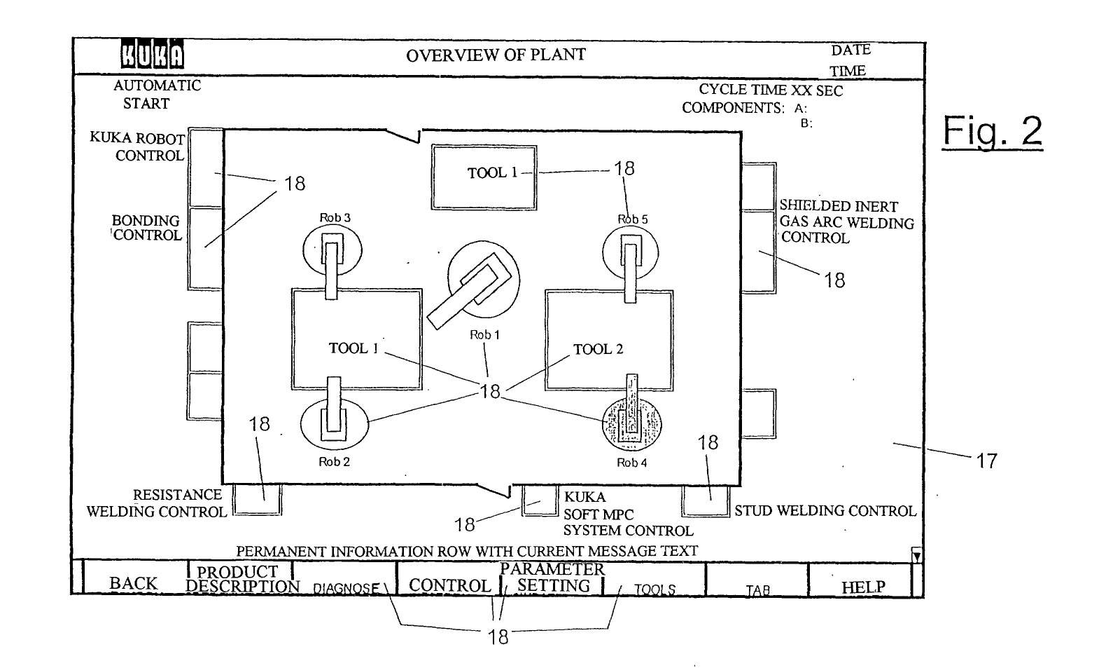

FIG. 2 shows a homepage of the production system and the intelligent system components,

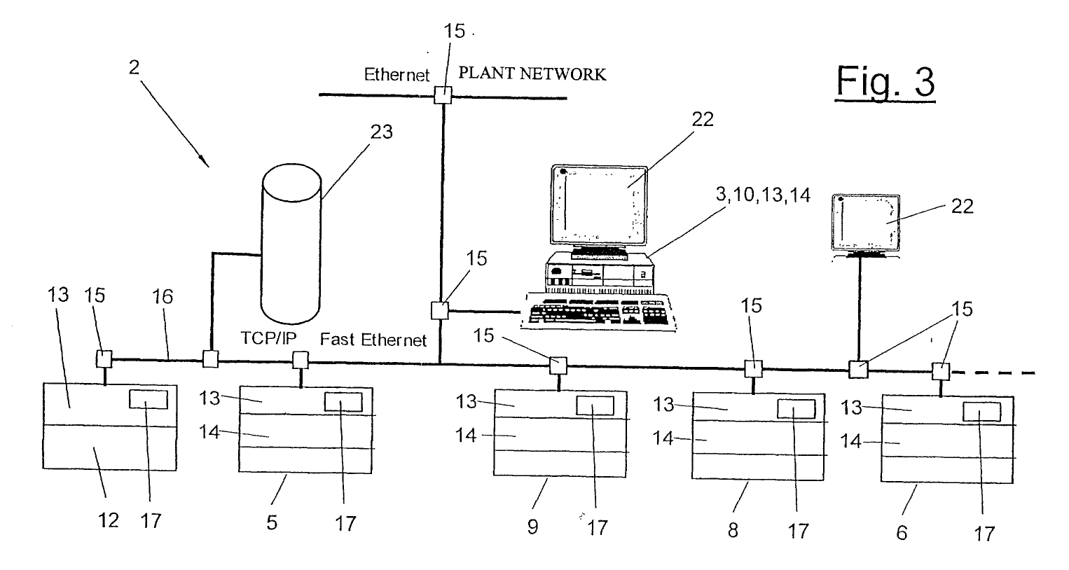

FIG. 3 shows a figure of the control architecture of the WEB control system,

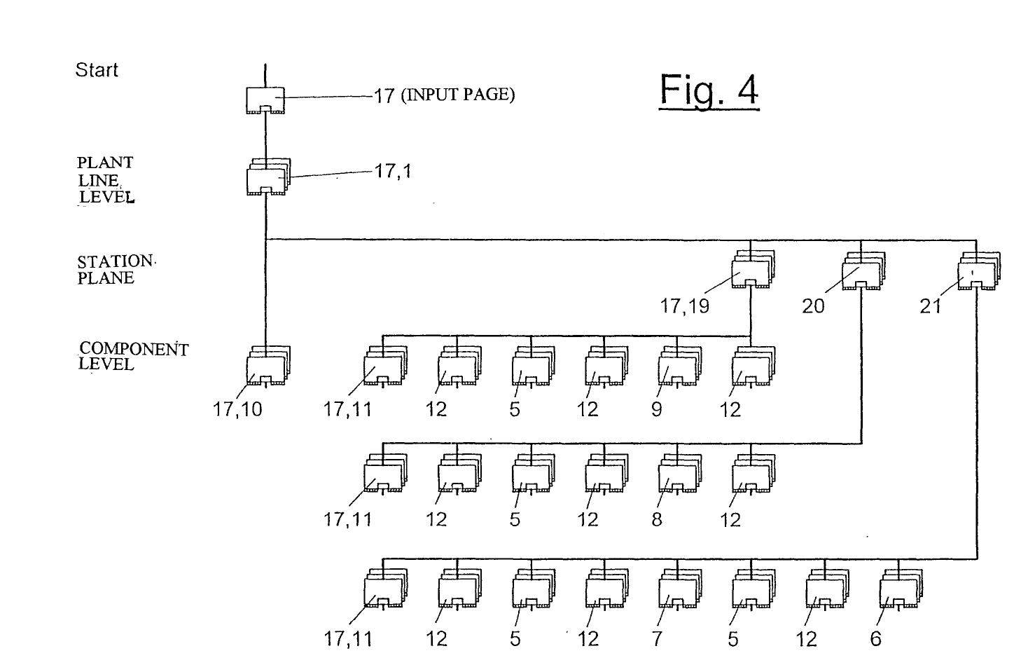

FIG. 4 shows a structural view of the homepage,

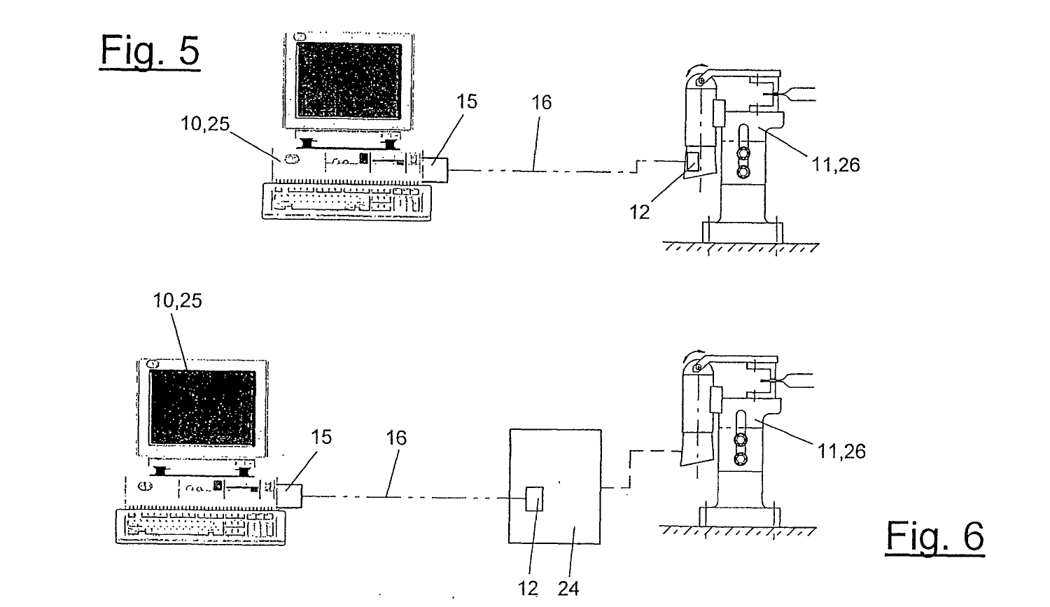

FIG. 5 shows a WEB control system with sequence control and tool with embedded chip,

FIG. 6 shows a variant of FIG. 5 with intelligent interface, and

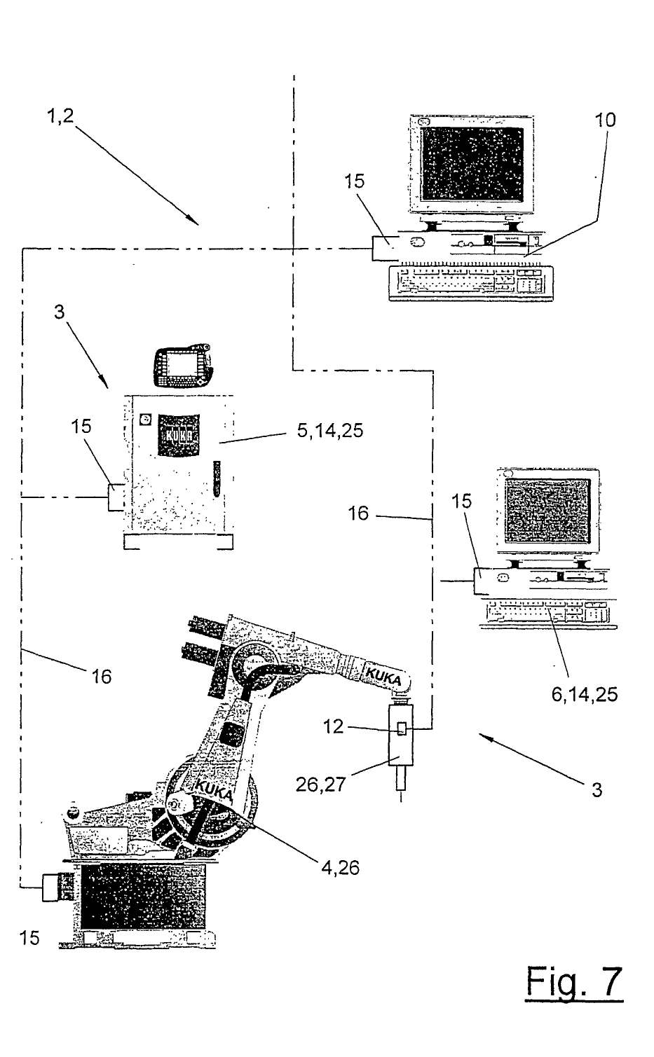

FIG. 7 shows a side view of a part of the production system according to FIG. 1.

FIGS. 1 and 7 schematically show an industrial production system (1). It is preferably used in the automobile industry and is used to manufacture components of vehicle bodies. The components are not shown for clarity's sake. The production system (1) is designed as a production cell in this exemplary embodiment being shown, but it may also have any other form and design. Three processing areas (19, 20, 21) for the components are arranged in the production system (1), and the components are fed in via a place of deposit for components (not shown) and removed after the processing. Moreover, additional and other transfer sites may be present for components, tools and other elements.

Any process, e.g., handling and processing operations, may take place in the production system (1). The processing may likewise be of any desired nature, e.g., spot welding, inert-gas shielded arc-welding, bonding, assembly, machining, etc.

The production system (1) has at least one system control (10) and a plurality of intelligent application components (3), which are designed as processing devices. The intelligent application components (3) are controlled by the system control (10) with a WEB control system (2) and are connected to one another by a data network (16).

The WEB control system (2) comprises a plurality of WEB servers (13) associated with the intelligent application components (3) with at least one homepage (17) each belonging to them and with at least one interface (15) each for the connection to the data network (16). Each intelligent system component (3) preferably has a WEB server (13) of its own here with at least one homepage (17) of its own. Suitable display and operating devices (22) may be associated with the WEB servers (13). As an alternative or in addition, one or more separate display and operating devices (22) may be present and connected to the data network (16).

The display and operating devices (22) and the WEB servers (13) are equipped with a suitable communications software. In particular, WEB browsers for displaying and operating the corresponding homepages (17) are installed on the display and operating devices (22). The data network (16) is preferably designed as a Fast Ethernet data network using the TCP/IP protocol. The interfaces (15) are also designed correspondingly and are designed, e.g., as Fast Ethernet plug cards. The above-mentioned components correspond to the common Internet standards in terms of software and hardware. In case of a change in the Internet standards, a corresponding adaptation of the components may be performed.

The intelligent application components (3) comprise a control part (25) and a device part (26) each. At least one system control (10), which comprises an industrial PC with a software-based sequence control running on it, is present for the control of the entire production system (1). At least one application or run-off program is running on the sequence control. At least the system control (10) preferably also has a display and operating device (22). The system control (10) preferably controls all intelligent application components (3) present via the common Fast Ethernet data network (16). The control takes place in application-related real time.

The WEB servers (13) have a separate IP address each and can be accessed directly. Bridges and rooters, with which the entire data network (16) can be segmented into smaller deterministic data networks, may be integrated in the data network (16). Moreover, the rooters control the data traffic while setting priorities and give priority to the time-critical control data before other data. As a result, a very rapid and purposeful exchange of the control data can be achieved. The control data being exchanged during the control operations consist of, e.g., control commands of the control units (10, 14, 25) and feedback of the accessed receivers. These may be, e.g., acknowledgments of receipt, and a so-called handshake may also be performed to check and secure the data traffic. In addition, the receivers report the performance of the control commands back to the control units (10, 14, 25), which is likewise monitored with a handshake. Furthermore, diagnosis data, programs or other data may be exchanged as well.

Moreover, special software modules, which are based on the TCP/IP protocol and ensure the exchange of the control data in application-related real time by ordering and optionally tightening up the control data in a suitable manner and grouping them in suitable data packages in order to expedite the normally not very fast data traffic under the TCP/IP protocol, are implemented in the WEB servers (13).

The intelligent application components (3) in the production system (1) being shown may be designed as various and any processing means. In the embodiment being shown, they comprise, on the one hand, a plurality of multiaxial robots (4) along with at least one robot control (5), which handle and/or process, e.g., grasp, transport, clamp, fit, weld, bond, etc., the components by means of suitable tools (27). For example, a welding tool (27) is shown schematically in FIGS. 1 and 7.

The intelligent application components (3) comprise additional processing means, which comprise robot-guided or stationarily arranged device parts (26) or application tools and corresponding process controls (25, 14). A inert-gas shielded arc-welding control (6), a resistance welding control (8), a stud welding control (7) and a bonding control (9) are shown for this in FIGS. 1 and 2. The said application components (3) comprise, furthermore, suitable supply means for operating materials, e.g., a feed means for welding wire, protective gas, welding current, etc.

The intelligent application components (3) include, furthermore, the workpiece seats present at each processing area (19, 20, 21) and tools (11) for the said seats, especially clamping tools. They are, e.g., directly connected to the system control (10). The system control (10) may be the only and directly acting control component (25) for these tools (11). The system control (10) forms the control part (25) and the tool (11) the device part (26) of the intelligent application component (3) here.

In a first embodiment, which is shown in FIG. 5, the tools (11), here clamps, are provided with a limited intelligence (12), e.g., a so-called embedded chip. The functions of this embedded chip will be specifically described below. In the variant according to FIG. 6, the tool (11) is connected to an interface (24), which has a suitable intelligence (12), e.g., an embedded chip. A plurality of tools (11) may also have a common interface (24). In an alternative, which is not shown here, the tools (11) may also have a more comprehensive intelligence (12) or control of their own in a higher-quality design.

Moreover, a system server (23) may be connected to the data network (16) via an interface (15).

The control parts (25) of the intelligent application components (3) have at least one computer (14) each, which is preferably designed as a personal computer, especially an industrial PC, or, in a simpler design, as a microprocessor. The computers (14) may have suitable, directly connected input and output devices (22), so-called HMI (human-machine interfaces). These are, e.g., a keyboard, a mouse, a marker pen, and suitable display devices, which are preferably designed as screens with graphics capability, e.g., as touch screens.

In the exemplary embodiment being shown, the system control (10) has a PC of its own. In a variant, not shown, the system control (10) may also be designed as a software-based sequence control, which runs on another intelligent application component (3), i.e., the robot control (5). The display and operating device (22) of the intelligent application component (3) may also be used for the system control (10) in this case. A conventional PLC system control with a suitable adaptation or expansion for the integration of a WEB server (13) may be used in another variant.

The intelligent application components (3) or their control parts (25) or computers (14) contain the aforementioned WEB server (13) with server and client function and with at least one homepage (17) belonging to the application component (3) with one or more dynamic fields (18) or buttons with links. A plurality of additional, hierarchically structured homepages may be subordinated to the homepage (17). The display and operating devices (22) and especially the additional devices may have a pure client function. They are equipped with a browser for displaying HTML or XML homepages. FIG. 2 shows the homepage (27) of the production system (1), which is preferably common to all WEB servers (13). The separate homepages (17) of the respective intelligent system components (3) can be reached via the links (18) and scroll there further in the subordinate homepages. FIG. 4 shows an exemplary architecture of the homepages (17).

The various intelligent application components (3) preferably have a separate WEB server (13) each. The WEB servers (13) and the computers (14) belonging to them are preferably equipped with such a large memory that they are able to internally store and manage at least their first own homepage (17) and the possibly subordinated homepages. As an alternative, the subordinate homepages (17) may also be stored on other WEB servers (13) in the case of simple computers (14), which comprise only a microprocessor control with a limited internal memory.

The control parts (25) or computers (14) of the intelligent application components (3) with their corresponding device parts (26) or tools (11, 27), e.g., actuators, sensors or the like may also be connected via Fast Ethernet lines and corresponding interfaces for the signal exchange in terms of control engineering. Thus, there also is a WEB control system with data network between the control parts (25) and the device parts (26).

FIG. 7 shows this, e.g., on the basis of a welding device (27) with a corresponding intelligence (12) on the hand of the robot (4) and the inert-gas shielded arc-welding control (6), which is in turn connected via a data network (16) with Fast Ethernet line and which is in turn connected to the system control (10) via the WEB control system (2) in terms of control engineering in the above-described manner. Likewise, the robot (4) or its individual components represent an intelligent device part (26), which is connected to the corresponding control part (25), namely, the robot control (5), in terms of control engineering in the above-mentioned manner. The device parts (26) now likewise have a WEB server (13) with a separate homepage in their intelligences (12), e.g., embedded chips. The data networks and WEB control systems existing within the intelligent application components (3) may be networked with the higher-level data network (16) and WEB control system (2) or be integrated within same.

The system control (10) is connected to the aforementioned tools (11) via the Fast Ethernet network (15). If the tools (11) are equipped with an intelligence (12), especially an embedded chip, at least the first homepage (17) of the tools (11) may be stored on its WEB server (13), depending on the storage location. The remaining homepages are now stored, e.g., on the WEB server (13) of the system control (10). The interface (15) of the tool (11) or the interface (24) may be provided with an additional intelligence, which functions as a converter, which converts the bit signals of the tools (11) into the TCP/IP protocol of the Fast Ethernet network (16) and vice versa. The above-described device parts (26), e.g., tools (27), robot parts, etc., of the other intelligent applicant components (3) may also be equipped and designed in a corresponding manner.

The WEB control system (2) with the connected WEB servers (13) of the intelligent application components (3) makes possible the display of the operating states of the individual application components (3) and their operation in the “manual” mode. In addition, an automatic control of the intelligent application components (3), which is performed by the system control (10), is also possible via the WEB control system (2) and the data network (16).

The manual influencing and especially control of the intelligent system components (3) among each other takes place via the homepages (17) and their links (18). The homepage (17) of any other intelligent applicant component (3) can be accessed and the state of the component there can be observed from the homepage (17) on the display and operating device (22), e.g., a PC display screen, of the intelligent application component(s) (3).

The production system (1) may be operated and controlled manually, in principle, from any homepage (17) on the WEB server (13). However, this possibility of operation and control may be limited for safety reasons or for other reasons by, e.g., this being possible only from the WEB servers (13) from the location of which there is an undisturbed visual connection to the system component (3) being operated or controlled.

As is illustrated in FIG. 2, a homepage (17) has a plurality of standardized basic components and functions, which are represented, e.g., by means of dynamic fields in the lower horizontal image row. Functions and links for diagnosis, for control, for parameter settings, for a product description, for operating and programming tools, for help and for a jump back to the previous homepage are triggered by these dynamic fields (18). In addition, additional fields may be present.

The control program of the individual intelligent application components (3) runs on the respective control computer (14) belonging to it. The WEB server (13) converts the operating and control signals received from the system control (10) via the Fast Ethernet network (16) into signals which are processed by the control computer (14) and its control program. Individual or general drivers, which are stored on the WEB servers (13) of the individual intelligent system components (3) and/or in the system control (10) or its WEB server (13), may be present for this purpose. The internal control of the intelligent device parts (26) of the system components (3) also functions analogously by means of its control parts (25) or computers (14).

The manual operation of the individual intelligent system components (3) may sometimes take place only via the intermediary of the system control (10). This is true especially when the production system (1) is running in automatic operation and a manual intervention must be coordinated with the function of the system and with the function of the other components (3) of the system. Such a coordination may sometimes also be necessary in manual operation in order to prevent collisions or the like.

The operation, control and programming or parametrization of the intelligent application components (3) via the homepages (17) may take place in various manners and to a varying extent. For example, an application component (3) may be switched on and off by means of corresponding buttons and dynamic fields (18) in the homepage (17). Furthermore, programs, parameters, modes of operation or the like can be selected and modified or set. Movement processes, functions, etc., may now be modified, complemented or newly generated. A movement of the individual axes may take place by manual operation in the case of the robots (4).

The same influencing of the intelligent application components (3) is possible in the preferred embodiment by means of the WEB control system (2) by remote control as can also be performed on the respective corresponding control on the site and directly. The precondition is compliance with the corresponding safety regulations.

In addition, the homepages (17) offer the possibility for an on-site diagnosis and also for remote diagnosis, which can be performed by connection to the World Wide Web (www). Maintenance, especially remote maintenance, may also be performed within the framework of the diagnosis. At least the WEB server (13) of the system control (10) is preferably connected to the World Wide Web via at least one additional interface (15).

The production system (1) may be controlled automatically via the system control (10) and the other connected controls (6, 7, 8, 9). The signal exchange between the system control (10) and the other intelligent application components (3) takes place via the WEB servers (13) and the data network (16) with the TCP/IP protocol. The control signals are converted at the transmitter into the TCP/IP protocol and correspondingly converted back into the control signals for the computer controls (14) of the intelligent applicant component (3). The transmission of the control signals in manual and automatic operation and the processing in the computer controls (14) take place at a speed necessary for the safe operation for the personnel and the devices. The respective states and functions of the intelligent application components (3) are displayed on the homepages (17) by means of browsers. The homepages (17) are polled via corresponding browsers.

The intelligent applicant components (3) with the WEB servers (13) belonging to them are standardized and prepared by their manufactures to the extent that they are integrated within the data network (16) and the WEB control system (2) extensively automatically during the installation according to the plug-and-play principle. The homepages (17) belonging to them are also standardized by the manufacturers and completely provided with operating instructions, spare parts lists, system description and other similar information, so that the installation and documentation effort for the design and for the operator of the production system (1) is minimized.

Various variants of the embodiment shown are possible. The data network (16) is designed as an internal network within the system in the exemplary embodiment being shown. However, a networking of the same type, extending beyond the production system (1), e.g., a system network, to which various production systems (1) located at the same site or at different sites are connected. Moreover, the above-mentioned connection to the World Wide Web may be present as well. The number, arrangement and design of the intelligent application components (3) shown and described in the exemplary embodiment may be varied as desired and they may deviate from the exemplary embodiment shown. Likewise, the design of the homepages (17) and the dynamic fields (18) may also be changed as desired. In the intelligent application components (3), the internal control of the device parts (26) of these components may also take place as an alternative in the conventional manner with a suitable bus system, e.g., a professional bus system or the like.

### LIST OF REFERENCE NUMBERS

1 Production system, production site

2 WEB control system

3 Intelligent application component

4 Robot

5 Robot control

6 Shielded inert gas arc welding control

7 Stud welding control

8 Resistance welding control

9 Bonding control

10 System control, software-supported sequence control

11 Tool, clamping tool

12 Intelligence, embedded chip

13 WEB server

14 Computer, PC, microprocessor

15 Interface, Fast Ethernet card

16 Data network, Fast Ethernet network

17 Homepage

18 Dynamic field, button, link

19 Processing area

20 Processing area

21 Processing area

22 Display and operating device

23 System server

24 Interface

25 Control part

26 Device part

27 Tool, welding device

1. Process for controlling a said industrial production system (1), especially for manufacturing components of vehicle bodies, comprising one or more said intelligent application components (3), especially said multiaxial robots (4), welding, bonding or clamping means or the like, and at least one said system control (10), which is equipped with a said WEB server (13) with at least one said homepage (17) of its own according to the Internet standard, characterized in that the said system control (10) controls the said intelligent application components (3) by a said WEB control system (2) and a said data network (16), wherein the said intelligent application components (3) are equipped with a said WEB server (13) each with at least one said homepage (17) of its own according to the Internet standard.

2. Process in accordance with claim 1, characterized in that the said control parts (25) of the said intelligent application components (3) control the said device parts (26) belonging to them by a said WEB control system (2) and a said data network (16), wherein the said device parts (26) are equipped with a said intelligence (12) of their own or with a said intelligent interface (24) and with a said WEB server (13) each with at least one said homepage (17) of its own according to the Internet standard.

3. Process in accordance with claim 1 or 2, characterized in that all said system control(s) (10) and all said control parts (25) and said device parts (26) of the said intelligent application components (3) of the said industrial production system (1) are connected to one another and communicate with one another by means of a said common WEB control system (2) and said data network (16).

4. Industrial production system, especially for manufacturing components of vehicle bodies, comprising one or more said intelligent application components (3), especially said multiaxial robots (4), welding, bonding or clamping means or the like, and at least one said system control (10), which is equipped with a said WEB server (13) with at least one said homepage (17) of its own according to the Internet standard, characterized in that the said system control (10) and the said intelligent application components (3) are connected in terms of control engineering by a said WEB control system (2) and a said data network (16), wherein the said intelligent application components (3) are equipped with a said WEB server (13) of their own with at least one said homepage (17) of its own according to the Internet standard.

5. Production system in accordance with claim 4, characterized in that the said intelligent application components (3) have a said control part (25) and a said device part (26), which are connected by a said WEB control system (2) and a said data network (16) in terms of control engineering, wherein the said device part (26) is equipped with a said intelligence (12) of its own or with a said intelligent interface (24) and with a said WEB server (13) of its own with at least one said homepage (17) of its own according to the Internet standard.

6. Production system in accordance with claim 4 or 5, characterized in that all said system control(s) (10) and all said control parts (25) and said device parts (26) of the said intelligent application components (3) of the said industrial production system (1) are connected to one another by a said common WEB control system (2) and said data network (16).

7. Production system in accordance with claim 4, 5 or 6, characterized in that the said homepage (17) has one or more said links (18).

8. Production system in accordance with one of the claims 4 through 7, characterized in that one or more said display and operating devices (2) with a browser for displaying and operating the said homepages (17) are connected to the said data network (16).

9. Production system in accordance with one of the claims 4 through 8, characterized in that the said data network (16) is designed as a Fast Ethernet network and the said connected application components (3) and said WEB servers (13) have said interfaces (15) for the TCP/IP protocol.

10. Production system in accordance with one of the claims 4 through 9, characterized in that the said WEB servers (13) have a plurality of said hierarchically structured homepages (17).

11. Production system in accordance with one of the claims 4 through 10, characterized in that the said homepages (17) of a said WEB server (13) are stored partially on other said WEB servers (13).

12. Production system in accordance with one of the claims 4 through 11, characterized in that the said homepages (17) have display and/or control elements for the said corresponding application component (3).

13. Production system in accordance with one of the claims 4 through 12, characterized in that the said control parts (25) and the said corresponding device parts (26) or said tools (11, 27) of the said intelligent application components (3) are connected to one another via Fast Ethernet lines.

14. Production system in accordance with one of the claims 4 through 13, characterized in that the said data network (16) extends beyond the said production system (1) or is connected to another data network of the same type, especially a system network or the World Wide Web, wherein the said display and operating devices (22) connected there and located outside the said production system (1) have access to the said homepages (17) of the said intelligent application components (3) located within the said production system (1).
